(19) United States
(12) Patent Application Publication
(10) Pub. No.: US 2016/0034421 A1
(43) Pub. Date: Feb. 4, 2016

(54) DIGITAL PRE-DISTORTION AND POST-DISTORTION BASED ON SEGMENTWISE PIECEWISE POLYNOMIAL APPROXIMATION

(71) Applicant: INFINEON TECHNOLOGIES AG, Neubiberg (DE)

(72) Inventors: Thomas Magesacher, Villach (AT); Peter Singerl, Villach (AT); Martin Mataln, Velden (AT); Christian Schuberth, Villach-Landskron (AT)

(21) Appl. No.: 14/449,326

(22) Filed: Aug. 1, 2014

(51) Int. Cl. G06F 17/11; G06F 17/50

(52) U.S. Cl. CPC G06F 17/11; G06F 17/5009

(57) ABSTRACT

A nonlinear distorter is configured to mitigate nonlinearity from a nonlinear component of a nonlinear system. The nonlinear distorter operates to model the nonlinearity as a function of a piecewise polynomial approximation applied to segments of a nonlinear function of the nonlinearity. The nonlinear distorter generates a model output that decreases the nonlinearity of the nonlinear component.

### FIELD

The present disclosure relates to digital pre-distortion and post-distortion in non-linear systems, and more specifically, pre-distortion and post-distortion based on segment-wise and piecewise polynomial approximation.

### BACKGROUND

Nonlinearity is inherent in most systems confronting scientific endeavors, and present particular challenges to a wide array of scientific fields. The behavior of a nonlinear system is often described by a nonlinear system of equations. A nonlinear system of equations is a set of simultaneous equations in which the unknowns (or the unknown functions in the case of differential equations) appear as variables of a polynomial of degree higher than one. In other words, in a nonlinear system of equations, the equation(s) to be solved cannot be written as a linear combination of the unknown variables or functions that appear in it (them). Because nonlinear equations are difficult to solve, nonlinear systems are commonly approximated by linear equations (linearization).

A nonlinear system of equations, or nonlinearity, applies to nonlinear digital pre- and post-distortion schemes of nonlinear components or nonlinear systems with memory, such as power amplifiers for wireless-, wireline-, or optical-fiber-communication. Primary problems caused by system components exhibiting dynamic nonlinearity (i.e. nonlinear behavior with memory) are out-of-band emissions and in-band distortion, which lead to design problems such as low energy efficiency and degraded performance. Non-linear pre- or post-distortion schemes or combinations thereof attempt to mitigate the unwanted effects resulting from out-of-band emissions and in-band distortion by attempting to modify (pre- or post-distorting) input or output signals of nonlinear systems.

### BRIEF DESCRIPTION OF THE DRAWINGS

FIG. 1 is a block diagram illustrating a nonlinear system for utilizing nonlinear distortion according to various aspects described.

FIGS. 2A-2C are block diagrams illustrating nonlinear systems for utilizing nonlinear distortion according to various aspects described.

FIG. 3 is another block illustrating a nonlinear system for utilizing nonlinear distortion according to various aspects described.

FIG. 4 is graph illustrating approximation errors of piecewise polynomial approximation and polynomial approximation according to various aspects described.

FIG. 5 is a block diagram illustrating a distortion core of a nonlinear system according to various aspects described.

FIG. 6 is a block diagram illustrating a memory slice according to various aspects described.

FIG. 7 a block diagram illustrating another distortion core of a nonlinear system according to various aspects described.

FIG. 8 is a block diagram illustrating another memory slice according to various aspects described.

FIG. 9 is a diagram illustrating graphs of a method of mitigating nonlinear distortion according to various aspects described.

FIG. 10 is another flow diagram illustrating a method of mitigating nonlinear distortion according to various aspects described.

FIG. 11 is yet another flow diagram illustrating a method of mitigating nonlinear distortion according to various aspects described.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor, a process running on a processor, a controller, an object, an executable, a program, a storage device, and/or a computer with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

In consideration of the above described deficiencies of nonlinear systems, various aspects for mitigating the nonlinearity of different nonlinear components (e.g., power amplifiers, digital or analog transmit or receive chain components, hybrid digital and analog components, multi-input-multi-output (MIMO) components or other nonlinear devices) are disclosed. Nonlinear pre-distortion or post-distortion components, schemes or combinations thereof that are disclosed herein can operate to mitigate unwanted effects arising from nonlinear behaviors with memory, such as from out-of-band emissions or in-band distortions. The nonlinear distortion schemes disclosed can modify input or output signals of nonlinear systems by modeling nonlinear behavior of system components with segmentwise piecewise polynomial approximation operations.

For example, a nonlinear component such as a power amplifier or other communication component that generates nonlinearity can be modified to decrease these unwanted nonlinear effects as a result of operations of a distorter or a distortion component. The distortion component can be configured to generate piecewise polynomial approximations with adaptive or dynamic processes on segments of a nonlinear function that is generated by the nonlinear component(s) of the system, which can be dynamic in nature (having memory or memory effects). Different segments of the nonlinear function that correspond to different memory slices can be selected based on various criteria for parameters of the nonlinearity function. Segmentation or the process of selecting the segments can vary according to various criteria such as an approximation error, a polynomial order of the segments selected, and a number of the segments. Coefficients of one or more memory slices resulting from the nonlinear behavior of the components can be utilized to generate the segment-wise and piecewise approximations or an inverse of these approximations. Additional aspects and details of the disclosure are further described below with reference to figures.

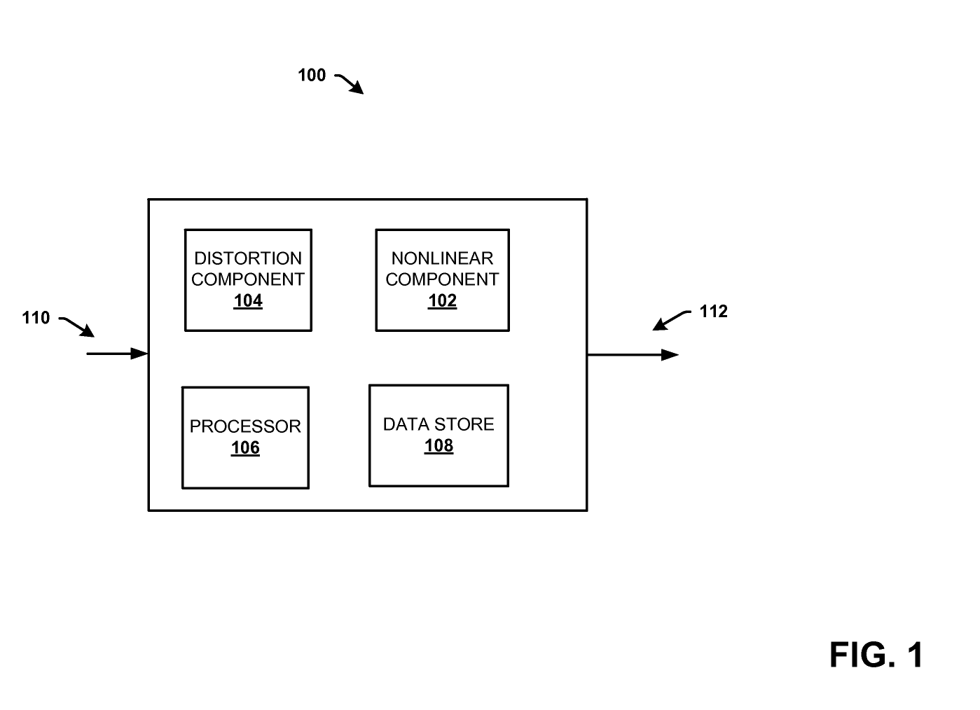

FIG. 1 illustrates an overview example for disclosure of a nonlinear system that generates nonlinearity and mitigates the nonlinearity according to various aspects. The system 100 comprises a nonlinear component 102 that generates nonlinearity characteristics in operation or in the output. The system 100 further comprises a distortion component 104 that operates to generate an output signal to improve the output of the nonlinear component 102 with more desirable properties by decreasing or eliminating nonlinearity.

The nonlinear component 102, for example, can comprise an amplifier such as a power amplifier for wireless, wireline, or optical-fiber communication. In other examples, the nonlinear component 102 can comprise an analog or a digital component of a communication transceiver, or a hybrid circuit component that separates transmit and receive signals. In particular, the nonlinear component 102 can comprise any device or device component that operates with, or generates an output having nonlinearity or distortion components.

The nonlinear component 102 can comprise a system, a system device, a device component, such as a power amplifier, an analog-to-digital converter, a digital-to-analog converter, a component of a receiver processing chain, a transceiver processing chain, or any other component or combination of component(s) for one or more different objectives. The nonlinear system 100 or nonlinear component 102 can exhibit or generate different degradation elements such as nonlinearity distortion, linear distortion, and a memory effect, in which the nonlinearity distortion and the memory effect can be referred herein as nonlinearity or dynamic nonlinearity and the behavior of which can be described according to one or more nonlinearity functions. Specifically, the nonlinear distortion refers to a waveform distortion caused by nonlinear characteristics of a system, device circuit or component with respect to an input or input amplitude, such as AM (amplitude modulation) AM and AM-PM (phase modulation) characteristics. Linear distortion can refer to the waveform distortion caused by linear frequency characteristics of the circuit (frequency characteristics appearing in a signal component), and the memory effect refers to the waveform distortion caused by a mutual relation between the nonlinear characteristics of the nonlinear component 102 and various frequency characteristics of the system 100 (frequency characteristics appearing in a distortion component). In a simple amplifier model, for example, utilizing only the nonlinear distortion (AM-AM and AM-PM characteristics), an output of the amplifier or of the nonlinear component 102 can be uniquely determined by the current input 110. However, when the linear distortion or the memory effect is present, in terms of a time domain, the output of the amplifier can be related, not only to the current input, but also to a previous input, previous state, and/or a previous output of the amplifier.

The system 100 comprises a distortion component 104, a processor 106 and a data store 108. The distortion component 104 can operate to decrease the nonlinearity exhibited by the nonlinear component or device 102 by modeling or generating a model of the nonlinearity of the nonlinear component, in which the model is generated based on a segmentwise piecewise polynomial approximation, or, in other words, a piecwise polynomial approximation for individual segments of a nonlinear function at one or more memory slices (memory effects at different iterations or time periods prior to or concurrent with the approximation operations). The distortion component 104 further operates to provide a model output that decreases the nonlinearity exhibited by the nonlinear component 102 in a system output 112. For example, in one aspect, the model output generated by the distortion component 104 can operate as a post-inverse component or as a post-inverse to the nonlinearity in order to mitigate, cancel or decrease the nonlinearity.

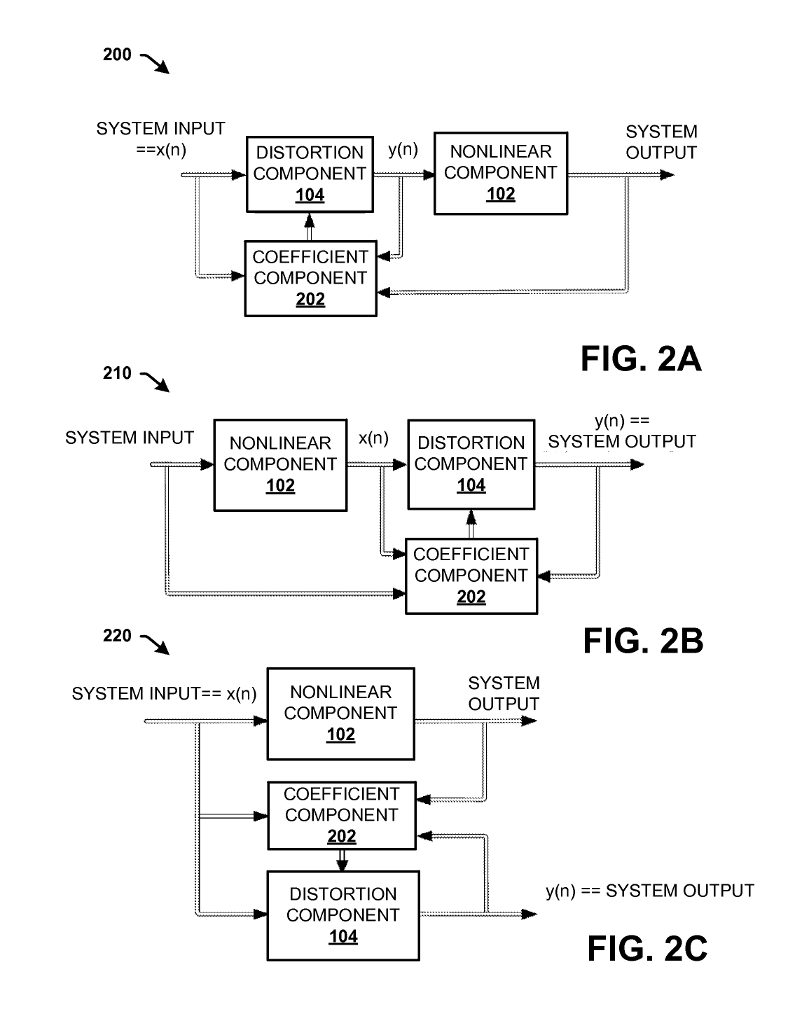

Referring to FIGS. 2a-2c, illustrated are examples of nonlinear systems that can utilize piecewise polynomial approximation to mitigate nonlinearity in accordance with various aspects disclosed. The nonlinear distortions disclosed, either pre-, post- or other model imitating function, can be digital or analog in nature, such as with a digital pre- or post-distortion and no particular one distortion type or combination thereof is confined by the operations and components of this disclosure.

FIG. 2a, for example, illustrates one nonlinear system 200 with a pre-distortion architecture that provides a pre-distortion to the nonlinear component 102 in order to decrease the nonlinearity being exhibited. The nonlinear system 200 comprises similar components as discussed above with the system 100 and further comprises a coefficient estimator or a coefficient component 202 that facilitates operation of the distortion component 104 to provide a model output y(n). The model output y(n) can comprise a pre-inverse of the nonlinearity in order to mitigate, decrease, or cancel the nonlinearity behaviors of the nonlinear component 102, especially out-of-band emissions or in-band distortions that lead to low energy efficiency and degraded performance.

The distortion component 104 acts as a pre-distorter to the nonlinear system component 102 that functions to model or predict the nonlinearity of the nonlinear component 102 and distort the nonlinearity such as by decreasing, mitigating or canceling nonlinear effects. For example, the distortion component 104, operating as a pre-distorter device, is fed with the input signal x(n) to the nonlinear system 200 and yields the modified output y(n). The model output y(n) is further fed into the nonlinear component 102 of the nonlinear system 200. An objective of the distortion component 104 as a pre-distorter device is to modify the input x(n) signal such that the system output signal of the nonlinear system component 102 (e.g., a power amplifier) has more desirable properties (e.g., low out-of-band emissions, low in-band-distortion or other such properties). The distortion component 104 as pre-distorter operates to imitate the pre-inverse of the nonlinear system component 102, for example, to inversely affect the nonlinearity via the input signal to the nonlinear component 102.

The coefficient component 202 is configured to process system input and output signals, and provide the distortion component 104 with coefficients for modeling nonlinearity behaviors via segmentwise piecewise polynomial approximations. The coefficient component 202 is further configured to receive the input x(n) and the output (system output) and estimate a set of coefficients. The estimation can be based on the input signal, the output and the model output y(n) being generated by the distortion component 104 to mitigate the nonlinearity from the processing operation. For example, the coefficient component 202 operates to estimate the set of coefficients that correspond to the nonlinearity of the nonlinear component for one or more memory slices. A memory slice, for example, can refer to a slice or a portion of the memory that is remaining or remembered from a previous input to the nonlinear system and also can influence the present nonlinear behavior of the nonlinear component 102 of the nonlinear system 200.

The coefficient component 202 can further operate to receive and process the input x(n) and an approximation error of the nonlinear system 200 according to a number of segments selected by a segmentation of a nonlinear function of the nonlinearity being outputted by the nonlinear component. Segments can refer to portions that are selected by a segmentation of the nonlinearity as expressed by a nonlinearity function being exhibited or expressed by the nonlinear component 102. Each segment can have segment parameters or boundaries that define the segment, such as disjunctions, discontinuities, linear portions, quadratic or other polynomial order portions of the segment, as well as boundaries expressed in a coordinate system, such as Cartesian, Polar, Spherical or the like. The coefficient component 202 can operate to generate or estimate coefficients related to the segments according to aspects disclosed herein and further detailed infra.

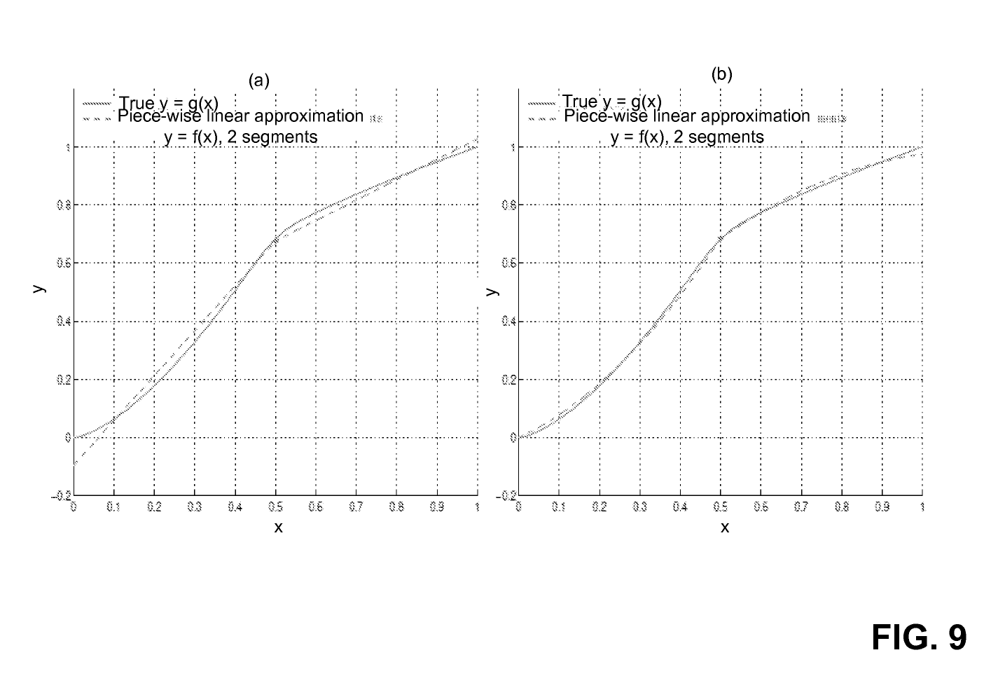

The coefficient component 202 can further operate to determine a segmentation of the segments. Segmentation can refer to how segments of nonlinearity corresponding to a particular memory slice are selected or segmented for analysis for the piecewise polynomial approximations of the individual segments. For example, segments of the nonlinearity can be selected based on discontinuous points or areas of nonlinearity based on an order P of complexity with regard to the segment. For example, a first order segment or linear segment could be selected; a second-order quadratic segment could be selected, and so on for analysis or for segment identification processes, which is further illustrated in FIG. 9 detailed infra. In addition, a number of segments can be selected (e.g., via a segmentation component 310 also detailed infra) to be analyzed for coefficient generation based on one or more criteria such as a number of discontinuities or nonlinear portions having one or more functional parameters for segmentation, degrees of non-uniformity, boundaries defining the segmentations, or other mathematical parameters related to nonlinear functions being expressed dynamically via the nonlinear system component 102 and being influenced by memory effects in memory slices.

The distortion component 104 is thus configured to generate one or more models of the nonlinearity as a function of a piecewise polynomial approximation of the nonlinear function that corresponds to the nonlinearity of the nonlinear component in real time via a number of N segments, in which N comprises an integer greater than one, and the N segments can comprise a P order of complexity. The order P of complexity can comprise an integer that is equal to or greater than one, such as two, for example.

FIG. 2b illustrates another important application involving post-distortion within a nonlinear system 210. The distortion component 104, for example, acts as a post-distorter in the nonlinear system 210 because it is fed with the output of the nonlinear system component 102 (e.g., as a receiver chain) as the input x(n) and yields a modified output signal or model(ed) output y(n) as the system output. The nonlinear component 102 of the nonlinear system 210 can also provide an input as the system input in this case. One objective of the distortion component 104 of the nonlinear system 210 as a post-distorter is to yield an output signal y(n) as the system output with more desirable properties (typically, a decrease in nonlinear distortion or a low nonlinear distortion). The system 210, for example, thus operates to decrease the nonlinear distortion exhibited by the nonlinear component 102 more than the decrease demonstrated by other forms of distortion such as by polynomial approximation methods alone. The distortion component 104 as a post-distorter is configured to imitate the post-inverse of the nonlinearity of the nonlinear system component 102.

The coefficient component 202, as discussed above, can provide coefficients according to different criteria, such as approximation error, number of segments, segmentation criteria, the previous inputs to the coefficient component and the system, and other criteria discussed herein. The coefficient component, for example, can operate any one of coefficient estimation process, such as a set of least squares estimations or other estimation operations for determining a set of coefficients for piecewise polynomial approximations to various individual segments of memory slices via the distortion component 104.

FIG. 2c illustrates another nonlinear system 220 configuration that comprises a system model imitation or identification, in which pre-distortion or post-distortion of the nonlinear component 102 can be dynamically (in real time, or on the fly) implemented or implemented in a predetermined manner depending upon system needs and configurations. For example, the distortion component 104 can dynamically imitate or model the nonlinear system itself and provide a model output y(n) for use as either pre-distortion, post-distortion or other mitigation of nonlinearity at the nonlinear component 102. The model output y(n) and/or the coefficients found during the identification or modeling process can then be used for further processing (for example, pre- or post-distortion). As one advantage, the distortion component 104 and the coefficient component 202 can operate to yield a better performance, or a greater decrease, in nonlinearity for even highly nonlinear systems, such as those systems considered to be a function of an infinite order polynomial, or high order polynomial, while keeping the complexity at the same level or not changing the overall complexity or order of the nonlinear component 102.

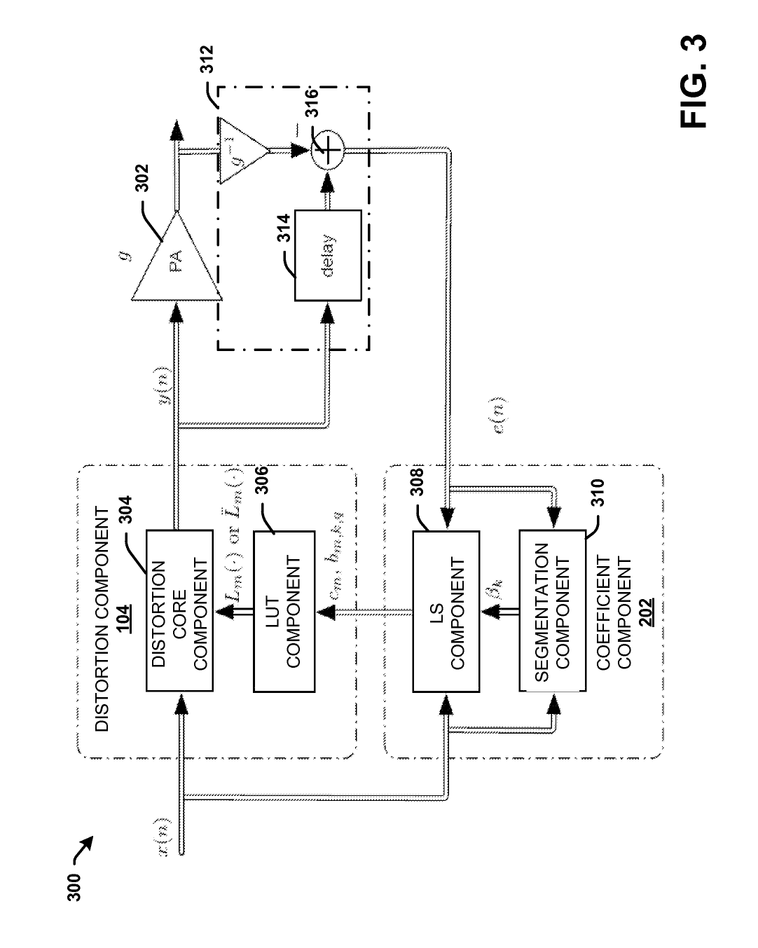

Referring now to FIG. 3, illustrated is a nonlinear system 300 that operates to mitigate nonlinearity in accordance with various aspects disclosed. The system 300 comprises a nonlinearity pre-distortion architecture as one of the examples discussed above, although other architectures are also envisioned such as a post-distortion or a dynamic modeling configuration, for example. The system 300 comprises the distortion component 104, the coefficient component 202, and a power amplifier 302 as the nonlinear component 102 discussed above.

In one aspect, approximating nonlinear static functions, which are the building blocks of most common nonlinear dynamic models, involve polynomials. Examples include the Volterra series representation and all lower-complexity off-springs obtained by pruning such as, for example, the memory-polynomial (MP), the generalized memory-polynomial (GMP), the dynamic deviation reduction (DDR) approach, and others like approaches. While polynomial approximation works well for weakly nonlinear systems (i.e., systems that can be approximated with polynomials of moderate order), several advanced systems (for example, power amplifiers employing Doherty or envelope-tracking architectures) require polynomials of very high or infinite order for exact fitting. High-order polynomials imply a high number of parameters to be estimated, which complicates the system identification procedure. For systems that would require infinite-order polynomials, a residual modeling error can remain and thus limits linearization performance. Consequently, adaptive procedures for modeling the nonlinear system are employed. As discussed above, piecewise polynomial approximations are generated for individual segments.

The memory polynomial (MP) model can be popular since it can be implemented using only one lookup table (LUT) per memory depth or slice. Aspects disclosed herein can further provide a modification of the MP model with a PWP approximation approach using an extension of the global representation of segment-wise piecewise linear functions.

The distortion component 104 of the nonlinear system 300 comprises a distortion core component 304 and a look up table (LUT) component 306. The distortion core component 304 carries out run-time processing of the input x(n) and generates a model output y(n) as a function the output Lm(·) or \tilde{L}m(·) received from the LUT component 306. The LUT component 306 processes the coefficients cₘ, b_{m,k,q} provided by the coefficient component 202. The LUT component 306 further generates or updates lookup tables according to different implementation architectures of the distortion core component 304 discussed infra, Lm(·) (a CORDIC-based implementation) or \tilde{L}m(·) (for a multiplier-based implementation described below). The respective outputs Lm(·) or \tilde{L}m(·) of the LUT component 306 are fed into the distorter core 304, which generates an output based on the LUT values.

The coefficient component 202 comprises a least mean squared (LS) component 308 and an adaptive segmentation component 310. The coefficient component 202 processes the input signal x(n) and an error signal e(n), selects a suitable segmentation βk and yields the corresponding coefficients cₘ, b_{m,k,q}. Segmentation selection and the corresponding coefficients are determined in an iterative procedure via the LS component 308 and the segmentation component 310 respectively. For each iteration n, the segmentation component dynamically determines a segmentation βₖ(n) based on the error e(n-1) received from an error component 312, the coefficients cₘ, b_{m,k,q} are determined by the LS component 308 and a LUT table is updated according to Lm(·) or \tilde{L}m(·).

In another aspect, the functions of the distortion component 104 can be mathematically represented by the following equation:

y(n)=Σₘ₌₀^{M}w(n−Δₘ)(cₘ+Σₖ₌₀^{K}Σ_{q-1}^{Q}^{_{m,k}}b_{m,k,q}∥x(n−Δₘ)|−βₖ|^{q}). (Eqn. 1),

wherein w (n) is an implementation-dependent function of x(n), K denotes the number of segment boundaries βₖ, k ∈ {1, 2, . . . , K} used for segmentation of the input range (i.e., there are K+1 segments), β₀=0, Q_{m,k} denotes the polynomial order of segment no. k in memory slice no. m, and cₘ, b_{m,k,q} denote the model coefficients to be determined during the identification process. The delays Δ=Σ±ₗ₌₀^{m}δₗ are realized by delay elements 314 as z^{-δ}^{ₘ}, which allow for non-uniform uniform integer-delay lines (i.e., it allows for δₘ ∈ [symbol] and δₘ≠δₙ, m≠n). Alternatively, a uniform integer-delay delay line can be used (δₘ=c, c ∈ [symbol] ).

The system 300 further comprises an error component 312 configured to control the approximation error based on the number of segments and a segmentation of the number of segments. The approximation error is based on a nonlinearity function of the nonlinearity and an approximation of the nonlinearity function through the piecewise polynomial function with the number of N segments. In order to assess the approximation quality of the system, the error can be defined as a difference between a nonlinear function g(x) of the nonlinearity of the nonlinear component 302 and a PWP approximation of individual segments, represented as follows:

e(x)=f(x)−g(x), (Eqn. 2).

An overall relative error can be defined as:

$$10 {log}_{10} \frac{{E}_{x} ( {\vert e ( x ) \vert}^{2} )}{{E}_{x} ( {\vert e ( x ) \vert}^{2} )} , \qquad ( Eqn . 3 ) ,$$

where Eₓ(·) denotes the expectation of · with respect to x.

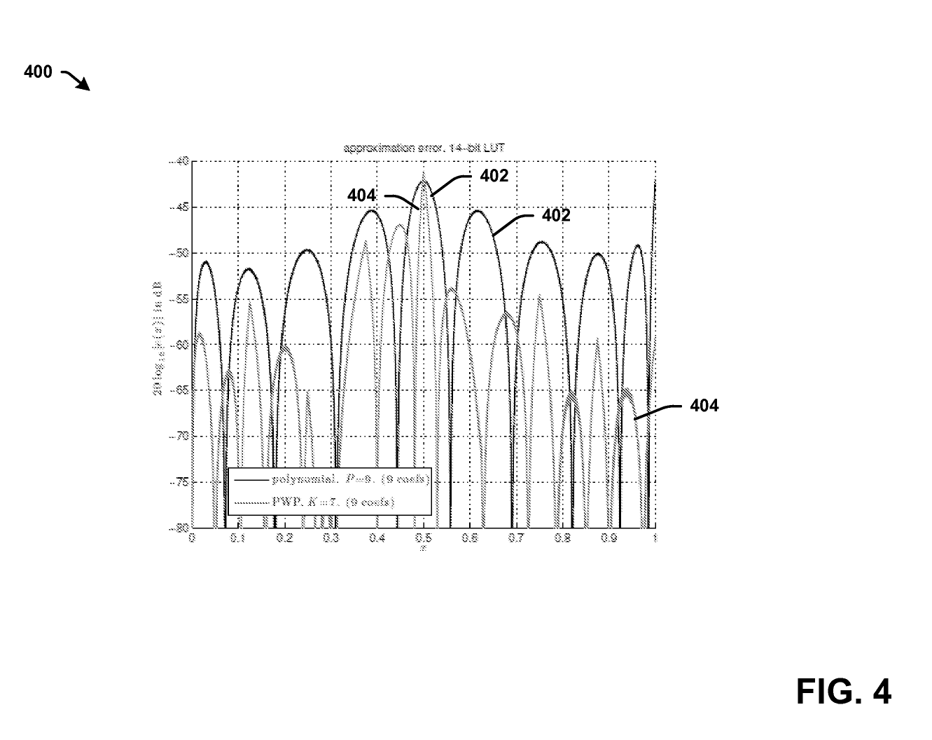

In an example, FIG. 4 illustrates a graph of an error in accordance with various aspects disclosed. For example, graph 400 illustrates the approximation error when utilizing a polynomial p(x) of order P=9 and a first-order PWP function f(x) with K+1=8 segments. Both p(x) and f(x) are described by 9 parameters (the PWP function f(x) with K segment boundaries has K+1 segments and K+2 parameters). As delineated, PWP approximation clearly outperforms polynomial approximation.

Further, Table 1 below compares the two approximations methods for different model complexities (number of parameters). To summarize, the proposed PWP-approximation method has two advantages over state-of-the-art polynomial approximation of nonlinear functions:

TABLE 1
PWP vs polynomial approximation of exemplary function g(x)

| | | number of | approximation |
|---|---|---|---|
| case | model | coefficients | error E |
| 1 | polynomial, order 5 | 5 | −36.1 dB |
| 2 | PWP, uniform, K = 3 | 5 | −45.4 dB |
| 3 | polynomial, order 7 | 7 | −41.2 dB |
| 4 | PWP, uniform, K = 5 | 7 | −49.5 dB |
| 5 | polynomial, order 9 | 9 | −46.2 dB |
| 6 | PWP, uniform, K = 7 | 9 | −52.1 dB |
| 7 | polynomial, order 11 | 11 | −50.3 dB |
| 8 | PWP, uniform, K = 9 | 11 | −54.5 dB |
| 7 | polynomial, order 13 | 13 | −54.4 dB |
| 8 | PWP, uniform, K = 11 | 13 | −56.8 dB |
| 9 | polynomial, order 33 | 33 | −68.8 dB |
| 10 | PWP, uniform, K = 31 | 33 | −73.5 dB |
| 11 | polynomial, order 55 | 55 | −69.6 dB |
| 12 | PWP, uniform, K = 53 | 55 | −82.3 dB |

For highly nonlinear functions, PWP-approximation yields a lower approximation error than polynomial approximation. The approximation error of polynomial approximation can be controlled by the polynomial order. In general, higher orders yield lower approximation errors. However, high polynomial orders cause numerical problems in the implementation of a parameter estimator, which imposes a limit on the approximation error in practical systems. The approximation error of PWP-approximation in the nonlinear systems disclosed can be more easily controlled and decreased by the number of segments and the segmentation (especially when selecting non-uniform segments).

Referring back to FIG. 3, for example, the error component 312 can operate to determine and provide an error with each iteration via an inverter 312, a delay component 314 and an adder 316. The error (e(n)) is provided to the segmentation component 310 and the LS component 308. The segmentation component 310 thus operates to control an approximation error based on the number of segments and the segmentation (what segments to select) of the number of segments. The segmentation component 310 can operate to dynamically determine segmentation as a function of the error received.

Additionally, the LS component 308 can adaptively, dynamically or in real time determine coefficients corresponding to the nonlinearity function of a memory slice with a least square operation applied to the different segments of the nonlinearity function of the memory slice. The determination of these coefficients can operate as a function of the different segments selected, the number of the different segments selected, an approximation error, an order of complexity of the different segments selected, or a previous set of coefficients stored in a look up table corresponding to a previous memory slice. Therefore, lookup tables can be iteratively updated with the set of coefficients.

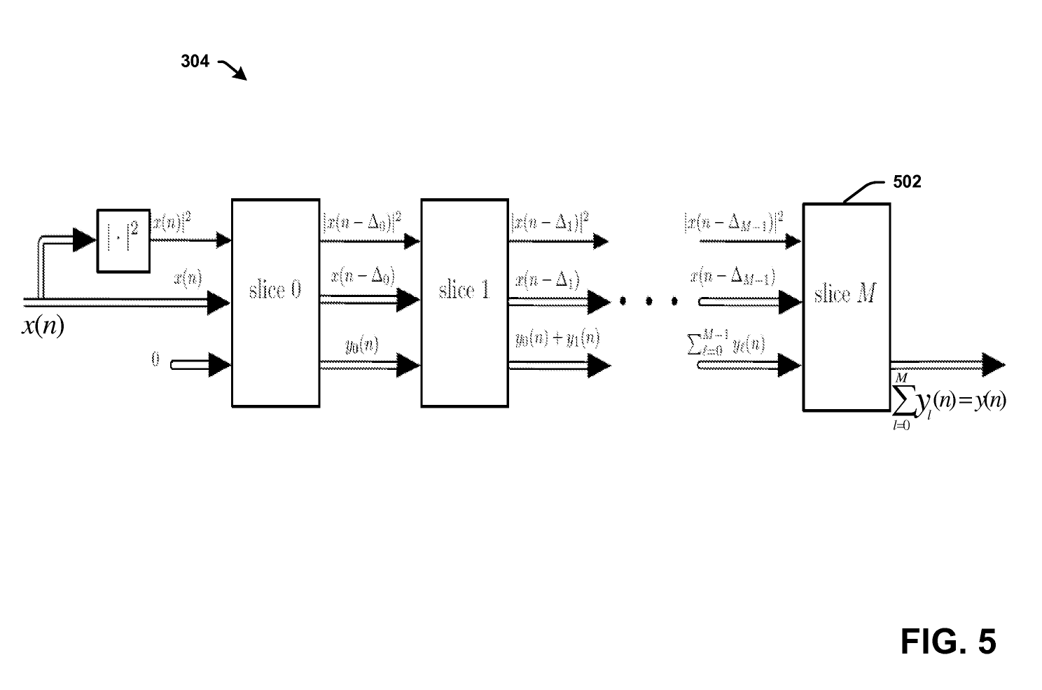

Referring to FIG. 5, illustrated is an example implementation of the distortion core component according to various aspects described. The distortion core component 304 is illustrated as one example that utilizes multipliers and provides a block diagram of a pre-/post-distorter core's top-level architecture essentially computing an output for each memory slice as a distortion model output y(n).

For example, the pre-/post-distorter core 304 can be a multiplier-based architecture that is independent of any Coordinate Rotation Digital Computer (CORDIC) components or CORDIC operations. The pre-/post-distorter core is given by Eqn. 1 above with w(n)=x(n) and can be written as:

y(n)=Σₘ₌₀^{M}yₘ(n), (Eqn. 4),

where yₘ(n) denotes the output of memory slice no. m given by

yₘ(n)=x(n−Δₘ) \tilde{L}ₘ(|x(n−Δₘ)|²), (Eqn. 5).

Each memory slice of the can be analyzed and implemented using a LUT \tilde{L}ₘ, which can be indexed by the squared magnitude |x(n−Δₘ)|² and generates, or returns, the coefficient \tilde{L}ₘ(|x(n−Δₘ)|²), in Cartesian coordinates. \tilde{L}ₘ(v²) is obtained through re-mapping from the lookup-table obtained during the identification process, expressed as follows:

Lₘ(v)=cₘ+Σₖ₌₀^{K}Σ_{q=1}^{Q}^{_{m,k}}b _{m,k,q}|v−βₖ|^{q}, v≧0 (Eqn. 6).

The distortion core component 304 thus operates at least two real multiplications computing |x(n)|² from the Cartesian input x(n) and M+1 memory-slice blocks (slice 0, slice 1, . . . slice M) computing (Eqn. 5).

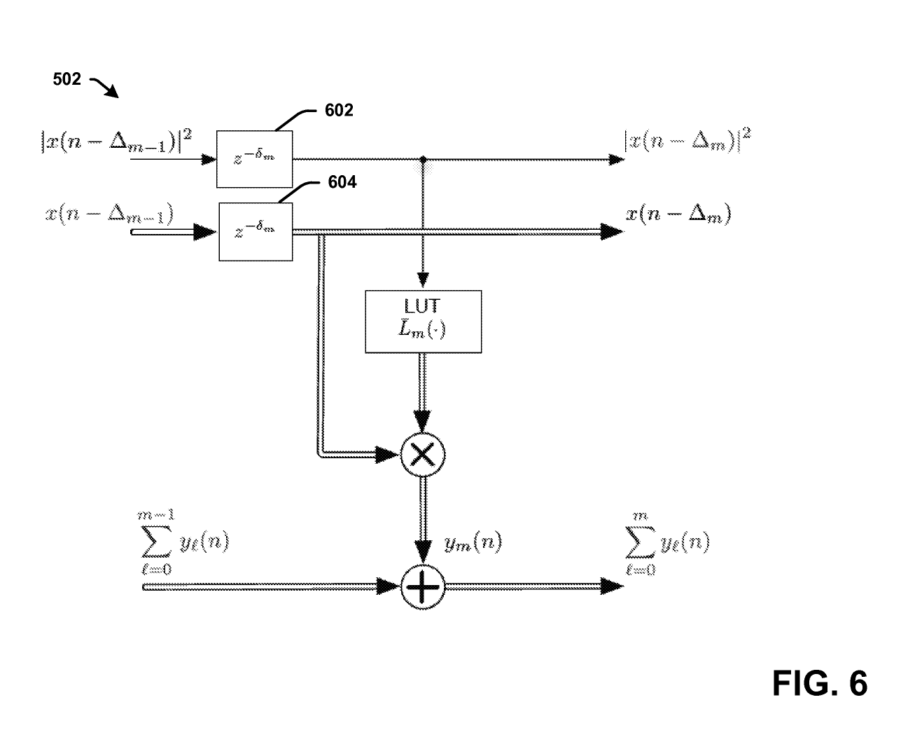

Referring to FIG. 6, illustrated is a block diagram detailing a memory slice (e.g., slice no. m) of a multiplier implementation illustrated above in FIG. 5. The block diagram 502 of memory-slice no. m is fed with the signal x(n−Δₘ₋₁) in Cartesian coordinates, the squared magnitude |x(n−Δₘ₋₁)|², and the intermediate result Σₗ₌₀^{m-1}yₗ(n) from the preceding memory-slice block in Cartesian coordinates, computes (Eqn. 5) and returns Σₗ₌₀^{m}yₗ(n)=yₘ₋₁(n)+yₘ(n) in Cartesian coordinates via multiplier and adder operation(s) with a prior result. Delays Δₘ=Σₗ₌₀^{m}δₗ can be realized by delay elements z^{-δ}^{ₘ} 602, 604 that allow for non-uniform integer delay lines (i.e., it allows for δₘ ∈ [symbol] and δₘ≠δₙ, m≠n). In this implementation, δ₀=Δ₀=0 in order to avoid latency. Alternatively, a uniform integer-delay delay line can be used (δₘ=c, c ∈ [symbol] ).

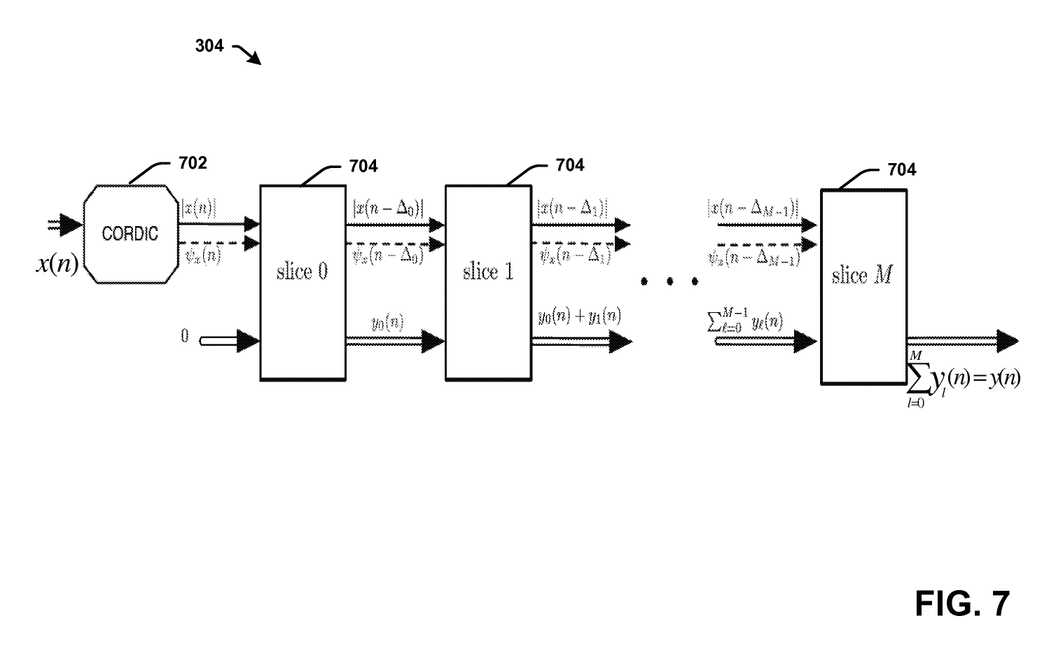

Referring now to FIG. 7, illustrated is an example implementation of the distortion core component that does not utilize any multipliers according to various aspects described. The distortion core component 304 is illustrated as one example that utilizes one or more CORDIC components and provides a block diagram of a pre-/post-distorter core's top-level architecture that computes an output for each memory slice as a distortion model output y(n).

The distortion core 304 operating as the pre-/post-distorter core is a multiplier-free architecture that utilizes one or more CORDIC components 702 for generating coordinate conversions. The pre-/post-distorter core component 304 is given by (Eqn. 3) with w(n)=e^{jψ}^{ₓ}⁽ⁿ⁾, where ψₓ(n−Δ_{M})=arg(x(n−Δ_{M})) denotes the phase of x(n−Δ_{M}). Thus, the output of the core can be written as (Eqn. 7) similar to (Eqn. 4) above, which is y(n)=Σₘ₌₀^{M}yₘ(n), where yₘ(n) denotes the output of memory slice no. m given by

yₘ(n)=e^{jψ}^{ₓ}^{(n-Δ}^{ₘ}⁾ Lₘ(|x(n−Δₘ)|), (Eqn. 8).

Each memory slice can be efficiently implemented utilizing a lookup-table Lₘ given by (Eqn. 6) above, which can be indexed by the magnitude |x(n−Δₘ)| and generates, or returns, the coefficient Lₘ(|x(n−Δₘ)|) in Polar coordinates. The distortion core component 304 thus operates to compute (Eqn. 7) with one or more CORDIC components 702 converting x(n) from a Cartesian coordinate system to a Polar coordinate system and for M+1 memory slice blocks 704 in computing (Eqn. 8).

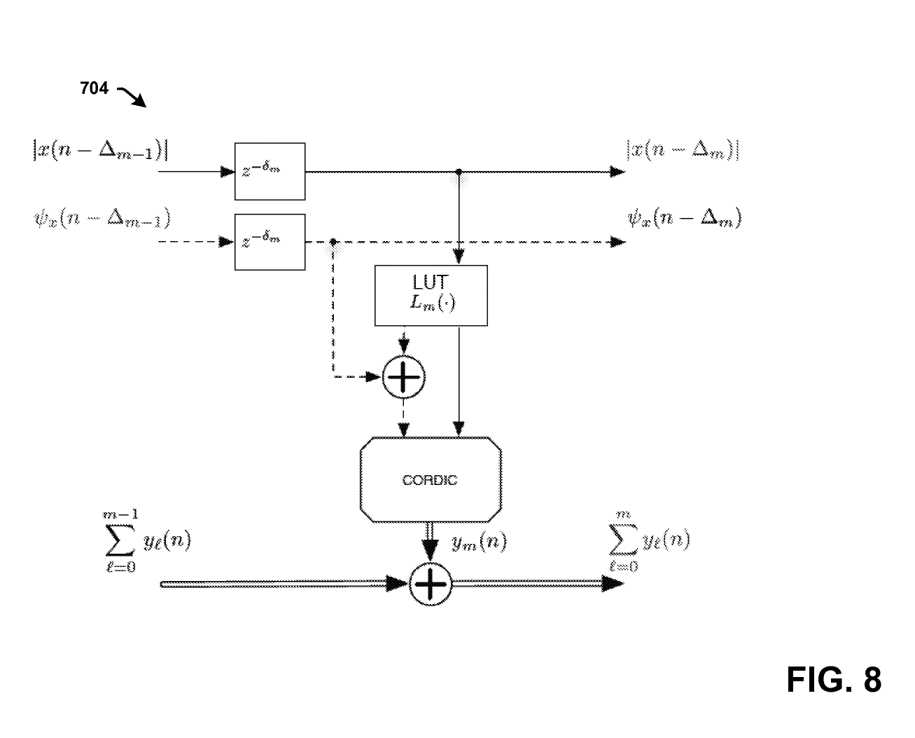

Referring to FIG. 8, illustrated is a block diagram 704 detailing a memory slice (e.g., slice no. m) of a CORDIC implementation or a multiplier free implementation illustrated above in FIG. 7. The block diagram 704 of memory-slice no. m is fed with the signal x(n−Δₘ₋₁) in Polar coordinates and the intermediate result Σₗ₌₀^{m-1} yₗ(n) from the preceding memory-slice block in Cartesian coordinates, computes (Eqn. 8) and returns Σₗ₌₀^{m}yₗ(n)=yₘ₋₁(n)+yₘ(n) in Cartesian coordinates. In addition or alternatively, it is possible also that δ₀=Δ₀=0 in order to avoid some latency.

Referring now to FIG. 9, illustrated is an exemplary nonlinear function g(x) and a PWP approximation f(x) according to a first-order (linear) PWP in (a) and a second-order (quadratic) PWP in (b). Instead of approximating g(x) by a polynomial, a piece-wise polynomial (PWP) approximation is generated by systems disclosed for individual segments. For example, two uniform segments are selected for a linear approximation, in which line segments are linearly approximated in (a) to the given function g(x) to fit linear segments, and line segments are quadraticly approximated in (b) to fit polynomial segments of order 2, in which segments greater than an order of two can also be selected.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

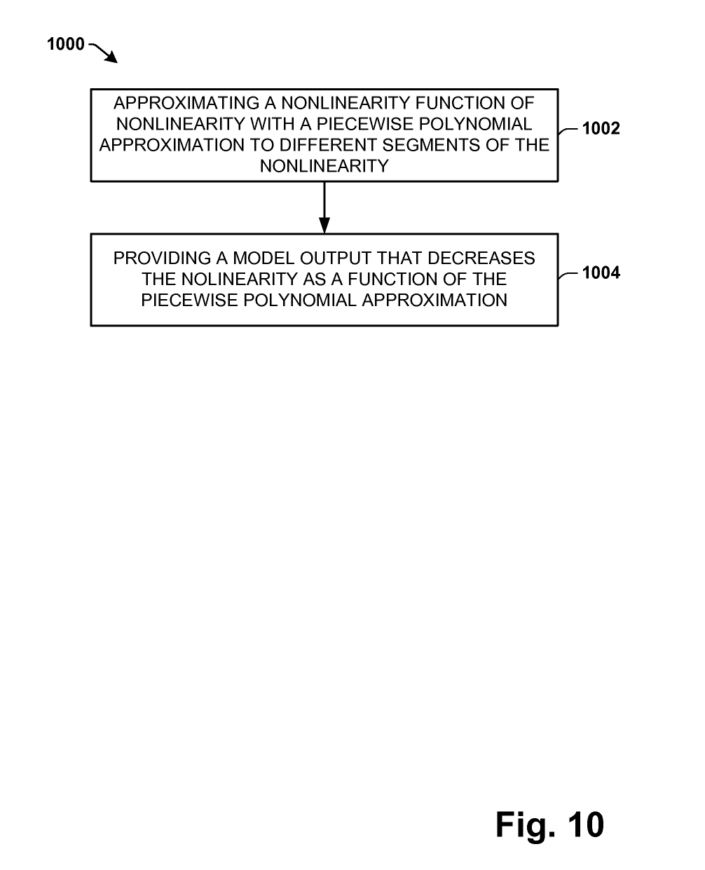

Referring to FIG. 10, illustrated is a method 1000 for mitigating or removing nonlinearity in a nonlinear system or component of the system in accordance with various aspects described. The method 1000 initiates, and at 1002 comprises approximating, via a processing device (e.g., the distortion component 104) coupled to a memory (e.g., data store 108), a nonlinearity function of the nonlinearity with a set of piecewise polynomial approximations to different segments of the nonlinearity.

At 1004, the method further comprises providing a model output that decreases the nonlinearity generated by the nonlinear component (e.g., nonlinear component 102) that comprises a post inverse of the nonlinearity function or a pre-inverse of the nonlinearity function that operates to decrease the nonlinearity in an output of the nonlinear component as a function of the set of piecewise polynomial approximations.

In other aspect, the method can further comprise determining an approximation error as a function of a nonlinearity function of the nonlinearity function and at least one piecewise polynomial function. The different segments of the nonlinearity function can be selected for operating piecewise polynomial approximation to a memory slice based on at least one of an approximation error, an order of complexity of the different segments or criteria discussed above.

The coefficient component of the system can also operate to adaptively determine a set of coefficients corresponding to the nonlinearity function of a memory slice with a least square operation applied to the different segments of the nonlinearity function of the memory slice as a function of at least one of the different segments selected, the number of the different segments selected, an approximation error, an order of complexity of the different segments selected, or a previous set of coefficients stored in a look up table corresponding to a previous memory slice. The system can then iteratively update at least one look up table with the set of coefficients.

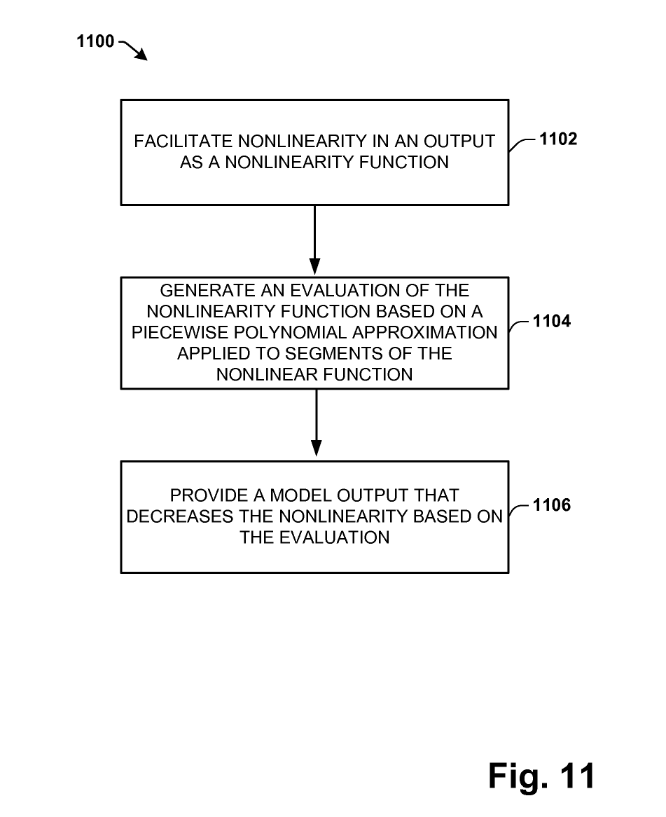

Referring now to FIG. 11, illustrated is a method 1100 for mitigating nonlinearity from a nonlinear behavior of a device (e.g., a mobile device) having at least one nonlinear component therein.

The method 1100 comprises, at 1102, operations to facilitate a nonlinearity in an output with a nonlinearity function via the nonlinear component. At 1104 the method operates to generate an evaluation of the nonlinearity function of the output based on a piecewise polynomial approximation that is applied to segments of the nonlinearity function. At 1106, the operations provide a model output that decreases a nonlinearity that is generated by the nonlinearity function based on the evaluation.

Applications (e.g., program modules) can include routines, programs, components, data structures, etc., that perform particular tasks or implement particular abstract data types. Moreover, those skilled in the art will appreciate that the operations disclosed can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer readable media can be any available media that can be accessed by the computer and includes both volatile and non-volatile media, removable and non-removable media. By way of example and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media (e.g., one or more data stores) can include, but is not limited to, RAM, ROM, EEPROM, flash memory or other memory technology, CD ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

It is to be understood that aspects described herein may be implemented by hardware, software, firmware, or any combination thereof. When implemented in software, functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor may be a microprocessor, but, in the alternative, processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may comprise one or more modules operable to perform one or more of the acts and/or actions described herein.

For a software implementation, techniques described herein may be implemented with modules (e.g., procedures, functions, and so on) that perform functions described herein. Software codes may be stored in memory units and executed by processors. Memory unit may be implemented within processor or external to processor, in which case memory unit can be communicatively coupled to processor through various means as is known in the art. Further, at least one processor may include one or more modules operable to perform functions described herein.

Techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical discs (e.g., compact disc (CD), digital versatile disc (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform functions described herein.

Further, the acts and/or actions of a method or algorithm described in connection with aspects disclosed herein may be embodied directly in hardware, in a software module executed by a processor, or a combination thereof. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to processor, such that processor can read information from, and write information to, storage medium. In the alternative, storage medium may be integral to processor. Further, in some aspects, processor and storage medium may reside in an ASIC. Additionally, ASIC may reside in a user terminal. In the alternative, processor and storage medium may reside as discrete components in a user terminal. Additionally, in some aspects, the acts and/or actions of a method or algorithm may reside as one or any combination or set of codes and/or instructions on a machine-readable medium and/or computer readable medium, which may be incorporated into a computer program product.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature may have been disclosed with respect to only one of several implementations, such feature may be combined with one or more other features of the other implementations as may be desired and advantageous for any given or particular application.

What is claimed is:

1. A nonlinear system for mitigating nonlinearity from a nonlinear behavior having memory or exhibiting a memory effect comprising:
a memory storing executable components; and
a processor, coupled to the memory, configured to execute or facilitate execution of the executable components, comprising:
a nonlinear component configured to process an input and provide an output that comprises a nonlinearity; and
a distortion component configured to generate a model of the nonlinearity of the nonlinear component based on a segmentwise piecewise polynomial approximation and provide a model output that decreases the nonlinearity.

2. The nonlinear system of claim 1, further comprising:
A distortion core component configured to generate an approximation of the nonlinearity or an inverse approximation based on the segmentwise piecewise polynomial approximation applied to a number of N segments of a function of the nonlinearity.

3. The nonlinear system of claim 2, wherein the number of N segments comprising a P order of complexity, wherein N and P comprise an integer of at least two.

4. The nonlinear system of claim 2, further comprising:
an error component configured to control an approximation error based on the number of segments and a segmentation of the number of segments, wherein the approximation error is based on a nonlinearity function of the nonlinearity and an approximation of the nonlinearity function through the piecewise polynomial function with the number of N segments.

5. The nonlinear system of claim 1, further comprising:
a coefficient component configured to receive the input and the output and estimate a set of coefficients based on the input signal, the output and the model output that is generated by the distortion component to mitigate the nonlinearity from the processing operation.

6. The nonlinear system of claim 5, wherein the distorter component generates the model output without changing a degree of complexity of the nonlinear component and is configured to model the nonlinearity of the nonlinear component as a function of the set of coefficients.

7. The nonlinear system of claim 6, wherein the distortion component is further configured to generate the model output based on the model comprising the input and a pre-inverse function or a post inverse function of the nonlinearity of the nonlinear component that mitigates the nonlinearity from the processing operation.

8. The system of claim 1, wherein the nonlinear component comprises at least one of a power amplifier, an analog component or a digital component of a communication transceiver, or a hybrid analog and digital component configured to separately transmit and receive signals.

9. The nonlinear system of claim 1, wherein the distortion component is further configured to generate the model of the nonlinearity by generating a segmentwise piecewise polynomial approximation or an inverse approximation of a nonlinear function that corresponds to the nonlinearity of the nonlinear component in real time via a number of N segments, wherein N comprises an integer greater than one, and the N segments comprise a P order of complexity, wherein P comprises an integer of at least two.

10. The nonlinear system of claim 1, further comprising:
a distortion core component configured to execute runtime operations of the input with a set of coefficients for a memory slice of the nonlinear behavior and the output that comprises the nonlinearity; and
a lookup table generator configured to receive a set of coefficients from a coefficient component and generate a lookup table to provide the set of coefficients to the distortion core component corresponding to the memory slice.

11. The nonlinear system of claim 1, further comprising:
a coefficient component configured to estimate the set of coefficients that correspond to the nonlinearity of the nonlinear component for the memory slice, process the input and an error based on a number of segments selected of a nonlinear function of the nonlinearity, and determine a segmentation of the number of segments.

12. The nonlinear system of claim 11, further comprising:
an adaptive segmentation component configured to determine the segmentation of the number of segments based on the error and an order of complexity of the number of segments and to select the number of segments of the nonlinear function upon which the segmentwise piecewise polynomial approximation operates.

13. A mobile device that mitigates nonlinearity from a nonlinear behavior of a nonlinear component, comprising:
a memory storing executable instructions; and
a processor, coupled to the memory, that executes or facilitates execution of the executable instructions to at least:
facilitate a nonlinearity in an output with a nonlinearity function via the nonlinear component;
generate an evaluation of the nonlinearity function of the output based on a piecewise polynomial approximation that is applied to segments of the nonlinearity function; and
provide a model output that decreases a nonlinearity that is generated by the nonlinearity function based on the evaluation.

14. The mobile device of claim 13, wherein the processor further executes or facilitates the execution of the executable instructions to:
determine, as a part of the evaluation, a set of coefficients that is a function of the input signal, the output signal and the modified output.

15. The mobile device of claim 13, wherein the processor further executes or facilitates the execution of the executable instructions to:
control an approximation error based on the number of segments and a segmentation of the number of segments.

16. The mobile device of claim 13, wherein the processor further executes or facilitates the execution of the executable instructions to:
generate a lookup table corresponding to a set of coefficients of the nonlinear function related to a memory slice of the nonlinear component.

17. The mobile device of claim 13, wherein the processor further executes or facilitates the execution of the executable instructions to:
determine a segmentation of the number of segments based on an approximation error of the number of segments.

18. The mobile device of claim 13, wherein the processor further executes or facilitates the execution of the executable instructions to:
identify a set of coefficients of the nonlinear function related to a memory slice with one or more least squares operations as part of the piecewise polynomial approximation; and
generate, via one or more multipliers, the evaluation by indexing a look up table for a set of coefficients corresponding to a memory slice in Cartesian coordinates.

19. The mobile device of claim 13, wherein the processor further executes or facilitates the execution of the executable instructions to:
identify a set of coefficients of the nonlinear function related to a memory slice with one or more least squares operations as part of the piecewise polynomial approximation; and
generate, via one or more CORDIC components and independent of a multiplier, the evaluation by indexing a look up table for a set of coefficients corresponding to a memory slice in Polar coordinates.

20. A method for mitigating nonlinearity in a nonlinear component comprising:
approximating, via a processing device coupled to a memory, a nonlinearity function of the nonlinearity with a set of piecewise polynomial approximations to different segments of the nonlinearity; and
providing a model output that decreases the nonlinearity generated by the nonlinear component that comprises a post inverse of the nonlinearity function or a pre-inverse of the nonlinearity function that operates to decrease the nonlinearity in an output of the nonlinear component as a function of the set of piecewise polynomial approximations.

21. The method of claim 20, further comprising:
determining an approximation error as a function of a nonlinearity function and at least one of the set of piecewise polynomial functions.

22. The method of claim 20, further comprising:
selecting the different segments of the nonlinearity function to a memory slice based on at least one of an approximation error or an order of complexity of the different segments.

23. The method of claim 20, further comprising:
adaptively determining a set of coefficients corresponding to the nonlinearity function of a memory slice with a least square operation applied to the different segments of the nonlinearity function of the memory slice as a function of at least one of the different segments selected, the number of the different segments selected, an approximation error, an order of complexity of the different segments selected, or a previous set of coefficients stored in a look up table corresponding to a previous memory slice; and
iteratively updating at least one look up table with the set of coefficients.

24. The method of claim 20, further comprising:
generating the model output as a function of a set of coefficients from at least one look table and at least one of a preceding output result of a preceding memory slice, a set of multiplications computing a magnitude of an input to the nonlinearity component in a Cartesian coordinate system, or a set of CORDIC computations without one or more multipliers computing the magnitude of the input to the nonlinearity component in a polar coordinate system.

25. The method of claim 20, further comprising:
controlling an approximation error of the model output based on a number of the different segments, a segmentation of the number of segments, and a polynomial order per segment.
